(19) United States
(12) Patent Application Publication
(10) Pub. No.: US 2005/0058865 A1
(43) Pub. Date: Mar. 17, 2005

(54) Self -thawing fuel cell

(76) Inventors: Eric L. Thompson, Honeoye Falls, NY (US); Robert Lee Fuss, Spencerport, NY (US); Timothy J. Keeler, Conesus, NY (US); James H. Lee, Rochester, NY (US); Stephen Raiser, Egelsbach (DE)

Correspondence Address: CARY W. BROOKS;General Motors Corporation, Mail Code 482-C23-B21, Legal Staff, P.O. Box 300, Detroit, MI, 48265-3000, US

(21) Appl. No.: 10/662,138

(22) Filed: Sep. 12, 2003

(51) Int. Cl. H01M 8/04

(52) U.S. Cl. 429/26; 429/23

(57) ABSTRACT

Electrical resistance heating elements recessed in the terminal plates, or the cell end plates, of a fuel cell stack at the interfaces therebetween are energized by electricity generated by the stack to heat the end cells during start-up of a frozen stack. The flow of current in the heating elements is ended when the temperature of the end cell(s) reach(es) a prescribed above-freezing temperature.

### TECHNICAL FIELD

This invention relates to H₂—O₂ fuel cell stacks, and more particularly to self-thawing such stacks that use electrical energy produced by the stack to heat the stack's end cells when starting-up a frozen stack.

### BACKGROUND OF THE INVENTION

H₂—O₂ fuel cells are well known in the art, and have been proposed as a power source for many applications. In such fuel cells, hydrogen is the anode reactant (i.e. fuel), oxygen is the cathode reactant (i.e. oxidant), and water is the reaction product. The oxygen can either be pure (i.e. O₂), or diluted with N₂ in the form of air. The H₂ can be provided either from a source of stored H₂ or from the reformation of a hydrogenous (i.e. hydrogen-containing) material such as gasoline or methanol. A plurality of individual cells are commonly bundled together to form a fuel cell “stack” which comprises a pair of end cells sandwiching a plurality of inboard cells therebetween.

There are several known types of H₂—O₂ fuel cells including aqueous-acid-type, aqueous-alkaline-type, and Proton-Exchange-Membrane-type (PEM). PEM fuel cells have potential for high power densities, and accordingly are desirable for motive-power/vehicular-propulsion applications (e.g. electric vehicles). PEM fuel cells include a “membrane electrode assembly” (a.k.a. MEA) comprising a thin, proton-transmissive, solid polymer membrane-electrolyte (typically made from ion exchange resins such as perfluoronated sulfonic acid) having an anode on one of its faces and a cathode on its opposite face. The anode and cathode typically comprise finely divided catalytic particles (often supported on carbon particles) admixed with proton conductive resin. The MEA is sandwiched between a pair of electrically conductive current collectors which contain a network of reactant flow channels therein defining a so-called “flow field” for distributing the H₂ and O₂ over the surfaces of the respective anode and cathode catalysts. The current collectors for the inboard cells of the stack are bipolar plates that conduct current directly through the stack in series from one cell to the next. The current collectors for each of the end cells include a bipolar plate on one side of the cell (i.e. facing the inboard cells), and a monopolar cell end plate on the other side of the cell (i.e. at the ends of the stack). A pair of terminal plates, one at each end of a fuel cell stack, engage the cell end plates of the end cells to collect the current produced by the stack. A load circuit connected to the terminal plates directs the current to (or from) an external electrical load (e.g. a propulsion motor) powered by the stack. Stack end plates, outboard the terminal plates, are attached to side plates on the stack (or to tie-bolts that extend the length of the stack), and serve to hold the stack together under compression.

The exothermic, current-producing electrochemical reaction (i.e. H₂+O₂→H₂O+heat) produces product water in situ within the cell during the normal operation of the fuel cell. In the case of aqueous acid or alkaline fuel cells, this product water is taken up by the electrolyte and does not freeze when the fuel cell is stored in a below-freezing environment. However, in a PEM fuel cell, the product water can freeze which (1) can plug/clog the reactant flow fields with ice, and prevent or restrict reactant gas flow, (2) can damage the polymer membranes, and (3) can exert deleterious pressures within the cells resulting from expansion of the water during freezing. Accordingly, it is known to dehydrate PEM fuel cells before storing them under freezing conditions. However, starting-up a frozen PEM stack still produces product water that can condense, freeze and damage and/or ice-clog the stack by blocking flow of the cell's reactants, especially in the flow-field and header/manifold regions near the current collectors which are particularly susceptible to ice-clogging. Even when ice-clogging is not an issue (e.g. in aqueous acid/alkaline fuel cells), poor performance from end cells (which are significantly colder than the inboard cells) prolongs the time it takes before the stack can generate full power.

It is known to selectively heat the end cells of a stack using electrical resistance heaters energized by the stack itself. It is desirable that such heaters be located as close as possible to the end cell for maximum thermal effectiveness (e.g. no heat losses to intervening materials). To this end Japanese laid open patent publication no. 8-167424 (hereinafter Pub. '424) discloses a PEM fuel cell stack having a heater plate energized by the stack which is positioned between the end cell plate and the terminal plate and in electrical series connection therewith. As a result, all of the stack current flows through the heater plate all of the time, even when the cell has reached its normal operating temperature. Such a structure results in unnecessary resistance to current flow in the load circuit when the stack is at its ordinary operating temperature. European Patent Application EP 1,283,558 A2 avoids the excessive resistance problem of Pub. '424 by locating the heater plate on the outside of the terminal plate. During cold start-up the heater plate is part of the load circuit and is energized by current from the stack. After the stack has reached a suitable above-freezing temperature, the current is caused to bypass the heater plate. In so doing however, EP 1,283,558 A2 moves the heater plate further away from the end cell, and thereby interposes an additional thermal impediment between the heater plate and the cell end plate which results in reduced thermal effectiveness. The present invention locates a stack-energized heating element in close proximity to the cell end plate for optimal thermal effectiveness without imposing unnecessary electrical resistance resistance on the load circuit during the operation of the stack at its normal operating temperature.

### SUMMARY OF THE INVENTION

The present invention relates to a self-thawing, and starting-up frozen (i.e. 0° C. or below) H₂—O₂ fuel cell stacks by electrically heating the end cells of the stack with energy generated by the stack itself during start-up. A self-thawing fuel cell stack comprises a plurality of individual fuel cells (hereafter cells) inboard of, and sandwiched between, a pair of end cells. The inboard and end cells are heated by heat from the exothermic H₂—O₂ reaction, and by Joule (i.e. I²R) heat produced by current flowing through the stack. The end cells are additionally heated by an electrical resistance heating element located immediately adjacent each end cell and energized by current drawn from the stack during start-up. More specifically, the stack includes (1) a fuel cell having a cell end plate, and a terminal plate abutting the cell end plate; (2) a terminal plate abutting each cell end plate; (3) a low resistance interface between the abutting plates; and (4) an electrical resistance heating element recessed in a face of either the terminal plate' or the end cell plate, for heating the end cells during start-up of a frozen stack. An electrical heater circuit electrically connects the heating element to the stack in electrical parallel with the load circuit when the end cell temperatures are below a prescribed temperature, and disconnects the heating elements(s) when the end cell temperature is at or above the prescribed temperature. The low resistance interface is formed where the terminal and cell end plates abut. Each heating element is recessed in the surface of one of the abutting plates, and has one of its ends electrically connected to the to the recess in which it resides. Electrical current generated by the stack is temporarily conducted through the heating elements to energize the heating elements during start-up from freezing temperatures. Thereafter the current is shunted around the heating element. Preferably, a layer of thermal insulation is provided between the heating elements and the ambient (e.g. between the heating elements and the stack end plates) to reduce heat loss from the end cells and the heating elements, and to permit the temperatures of the end cells to rise at about the same rate as the temperatures of the inboard cells. An electrical heater circuit communicates the heating element with the stack and may include one or more switches for initiating and maintaining current flow to the heating elements until the temperature of the end cells exceeds 0° C., and then terminating the current flow (i.e. turning off the heating elements). Preferably, the heating elements are not turned off until the temperature of the end cells is raised to a prescribed, above-freezing, target temperature, preferably about 20° C., and most preferably about 40° C.

The heating elements may be controlled in a variety of ways including (1) manually, or (2) automatically via temperature-responsive switches or materials. The length of time the heating elements are turned-on will vary with the starting temperature of the stack, the size of the heating elements, the amount of current available from the stack during startup, and the prescribed “heater-off” target temperatures. According to one embodiment, a thermo-mechanical (e.g. bi-metal) cut-out switch thermally contacts each end cell, and opens the heater circuit when the end cell's temperature rises to the prescribed above-freezing target temperature. Two thermo-mechanical switches, one for each end cell, may be used in electrical series with each other. When so series connected, the second switch may be set to open the heater circuit at an equal or higher temperature than the target temperature for the first switch, and hence switch 2 serves as a backup switch should the first cut-out switch fail to open at its prescribed temperature. Separate, heater circuits may be used for the heating elements so that the heater for each end cell is individually controlled, independently of the other heater. In still another embodiment, a clock/timer starts running as soon as the heater is energized, and, after a prescribed interval of time has elapsed, deenergizes the circuit (e.g. opens a cut-out switch). This interval of time may be the same for all starting temperatures, or may be adjusted to be longer for colder starts than for warmer starts. In this later regard, the duration of this time interval is controlled by a controller that receives a starting temperature input from a sensor that senses either the end cell temperature, or the ambient temperature, and, using an empirically-derived look-up table, ascertains an appropriate heating interval for that particular starting temperature. When a timer is used to shut off a heater, the heater circuit will preferably include a PTC-resistor that is in thermal contact with the end cell, and has a positive thermal coefficient (PTC) selected to stop current flow through the heater circuit if the end cell's target temperature is reached before the timer times out. Alternatively, the timer may be eliminated and the heater itself comprise a PTC-resistor material having a sufficiently high resistance at the prescribed target, heater-off temperature to substantially stop current flow through the heating elements when that temperature is reached and thereby divert all the current into the load circuit that parallels the heater circuit.

In its simplest variant, a cutout switch is manually opened by the fuel cell operator after a self-determined period of time has elapsed, or in response to a visual or audible signal triggered by a timer.

The heating elements need not heat the entire end cell, but rather may be selectively located in recesses located adjacent selected regions of the end cell (e.g. flow field headers/manifolds) that are most susceptible to becoming clogged with ice. Such selective positioning not only prevents ice-clogging in particularly ice-sensitive regions, but has the additional benefit of consuming less energy from the stack.

According to a preferred embodiment of the invention, electrically conductive terminal plates are provided at the ends of the stack that (1) contact each end cell, (2) collect the current from the stack and direct it, via a load-circuit to an external electrical load (e.g. propulsion motor) powered by the stack, and (3) have the heating elements recessed in the face thereof therein in electrical parallel to the load-circuit. The heating element preferably has a plurality of branches joined to a common buss at one end and interdigitated with a plurality of lands/ridges between the recesses on the face of the terminal plate. The lands/ridges directly engage (i.e. abut) the cell end plate and form a low resistance interface therewith without any interference from the recessed heating element. The distal ends of the forks' branches are electrically coupled to the recess in which it resides.

Method-wise, the invention comprehends starting-up a frozen H₂—O₂ fuel cell stack by: positioning an electrical resistance heating element adjacent each end of the stack; supplying H₂ and O₂ to the stack; electrochemically reacting the H₂ and O₂ in the stack to generate heat, electrical current, and water; conducting all or part of the electrical current generated by the stack in parallel with the load to energize the heating elements and heat the stack's end cells during start-up; and controlling the shut-off of the heating elements when the end cells reach a prescribed temperature. According to one embodiment, end cell heating continues for a prescribed, timer-controlled interval of time. According to another embodiment, the temperature of the stack's end cells is monitored by a thermo-mechanical switch, and the heating current terminated when that temperature reaches a prescribed, above-freezing target temperature. Preferably, the heating current is terminated when the slowest-to-heat end cell (which is typically at the anode end of the stack) has reached its target temperature that opens the switch. According to still another embodiment, the electrical resistance of the heating element is monitored as a telltale of the heater's temperature, and the heating current shut off when the heating elements resistance reaches a prescribed value that has been correlated to end cell temperature. The resistance is calculated from the voltage across the heating element and the current flow through the heater circuit which is correlated to heater temperature by a controller using empirically derived look-up tables.

### BRIEF DESCRIPTION OF THE DRAWINGS

The invention will be better understood when considered in the light of the following detailed description of certain specific embodiments thereof which is given hereafter in conjunction with the following drawings in which the same identifying numbers are used for like components throughout the several figures.

FIG. 1 is an exploded, isometric view of a self-thawing, PEM fuel cell stack showing individual cell component detail;

FIG. 2 is an exploded, abbreviated (i.e. sans cell detail), isometric view of a self-thawing, PEM fuel cell stack in accordance with one embodiment of the present invention;

FIG. 3 is a schematic of the electrical circuit of the embodiment depicted in FIG. 2;

FIG. 4 is an exploded, abbreviated, isometric view of a self-thawing, PEM fuel cell stack in accordance with another embodiment of the present invention;

FIG. 5 is a schematic of the electrical circuit of the embodiment depicted in FIG. 4;

FIG. 6 is an exploded, abbreviated, isometric view of a self-thawing, PEM fuel cell stack in accordance with yet another embodiment of the present invention;

FIG. 7 is a schematic of the electrical circuit of the embodiment depicted in FIG. 6;

FIG. 8 is an exploded, abbreviated, isometric view of a self-thawing, PEM fuel cell stack in accordance with one more embodiment of the present invention;

FIG. 9 is a schematic of the electrical circuit of the embodiment depicted in FIG. 8;

FIG. 10 is an exploded, abbreviated, isometric view of a self-thawing, PEM fuel cell stack in accordance with yet another embodiment of the present invention;

FIG. 11 is a schematic of the electrical circuit of the embodiment depicted in FIG. 10;

FIG. 12 is a plan view of one embodiment of a terminal plate and resistance heating element useful with the present invention;

FIG. 13 is a sectional view in the direction 13-13 of FIG. 12;

FIG. 14 is a plan view of another embodiment of a resistance heater useful with the present invention;

FIG. 15 is a sectional view in the direction 15-15 of FIG. 14;

FIG. 16 is a sectional view in the direction 16-16 of FIG. 14; and

FIG. 17 is a sectional view in the direction 17-17 of FIG. 12.

### DESCRIPTION OF SPECIFIC EMBODIMENTS

The invention is illustrated hereafter in the context of a PEM fuel cell stack, it being understood that the invention is also applicable to other H₂—O₂ fuel cell stacks of the type mentioned above. Like reference numerals are used for like components throughout the several figures.

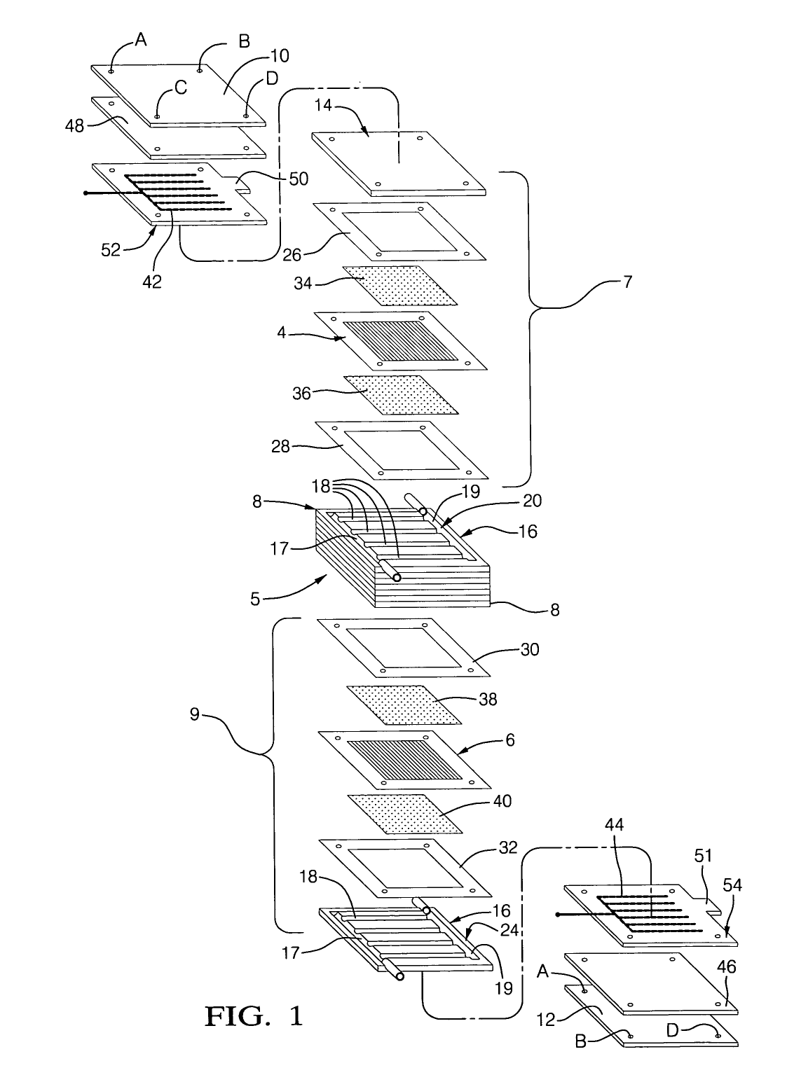

FIG. 1 depicts a PEM fuel cell stack having a plurality of inboard cells 5 sandwiched between a pair of exploded end cells 7 and 9, each comprising a membrane-electrode-assembly (MEA) 4 and 6, respectively. The MEA of each cell is separated from the next adjacent cell in the stack by an electrically conductive, liquid-cooled, titanium, bipolar plate (e.g. 8). The end cells 7 and 9 are completed by electrically conductive, monopolar, current-collecting, titanium, cell end plates 14 and 16 which define the termini of the stack. The several cells are stacked together between stainless steel, stack end plates 10 and 12. The monopolar, current-collecting cell end plates 14 and 16, as well as the several bipolar plates (e.g. 8) each contain flow fields 20 and 24 comprising a plurality of flow channels 18 extending across the faces of the plates for distributing fuel and oxidant gases (i.e., H₂ & O₂) to the anode and cathode faces of the MEAs 4 and 6. Inlet and outlet manifolds 17 and 19, respectively, supply and exhaust a reactant gas (i.e. H₂ or O₂) to and from the flow channels 18. Nonconductive gaskets 26, 28, 30, and 32 provide seals and electrical insulation between the several plates of the fuel cell stack. Porous, gas permeable, electrically-conductive sheets 34, 36, 38 and 40 (known as “diffusion media”) press up against the electrode faces of the MEAs 4 and 6 and serve as primary current collectors for the electrodes, as well as mechanical supports for the MEAs 4 and 6 where they span flow channels 18 in the flow field 20, 24. Suitable primary current collectors include carbon/graphite paper/cloth, fine mesh noble metal screens, open cell noble metal foams, and the like, which conduct current from the electrodes while allowing gas to pass therethrough to react on the electrodes. The current-collecting, cell end plates 14 and 16 press up against the primary current collectors 34 and 40 respectively, while the bipolar plates (e.g. 8) on the ends of the stack of inboard cells 5 press up against the primary current collector 36 on the anode face of MEA 4, and against the primary current collector 38 on the cathode face of MEA 6. Oxygen may be supplied to the cathode side of the fuel cell stack from a storage tank (not shown) via appropriate supply plumbing, while hydrogen may be supplied to the anode side of the fuel cell from a storage tank (not shown), via appropriate supply plumbing. Alternatively, the O₂ tank may be eliminated, and air supplied to the cathode side from the ambient. Similarly, the H₂ storage tank may be eliminated, and hydrogen supplied to the anode from a reformer which catalytically generates hydrogen from hydrogenous materials such as methanol or gasoline. Exhaust plumbing (not shown) for both the H₂ and O₂/air sides of the cells is also provided for removing H₂-depleted anode gas from the anode flow field, and O₂-depleted cathode gas from the cathode flow field. Additional plumbing (not shown) is provided for supplying and exhausting liquid coolant to/from the stack as may be needed.

Electrically insulated tension bolts (not shown) extending through the corner holes A, B, C, and D of the stack's components (e.g. plates, gaskets etc) may be used to clamp the several cells together to form the stack. Alternatively, the stack end plates 10 and 12 may be bolted to side plates (not shown) that extend the length of the sides of the stack.

Aluminum stack terminal plates 52 and 54 abut the monopolar, current-collecting, end cell plates 14 and 16, respectively, and serve as the current collectors and terminals for the entire stack. A low resistance interface is formed between the abutting plates 14 & 52 and 16 & 54. Terminal tabs 50 and 51 project from the terminal plates 52 and 54 for connecting the plates 52 and 54 via a load-circuit 49 to an external electrical load (e.g. a propulsion motor). A layer 48 and 46 of electrical/thermal insulation (e.g. Delrin® acetal resin plate, silicon foam, or the like) is provided at each end of the stack, between the terminal plates 52, 54 and the ambient, and preferably between the terminal plates 52, 54 and the stack end plates 10, 12 to electrically and thermally insulate the terminal plates 52, 54 from the end plates 10, 12, to prevent shorting, and to reduce heat losses from the end cells and the heating elements to the ambient. In the embodiment shown in FIG. 1, electrical resistance heating elements 42 and 44 are recessed in the faces of the terminal plates 52 and 54 at their interfaces with the abutting cell end plates 14 and 16 for applying heat to the end cells 7 and 9 during startup of a frozen stack. Alternatively, the heating elements 42 and 44 may be recessed in the external faces of the monopolar, current-collecting cell end plates 14 and 16 at their interfaces with the abutting terminal plates 52 and 54.

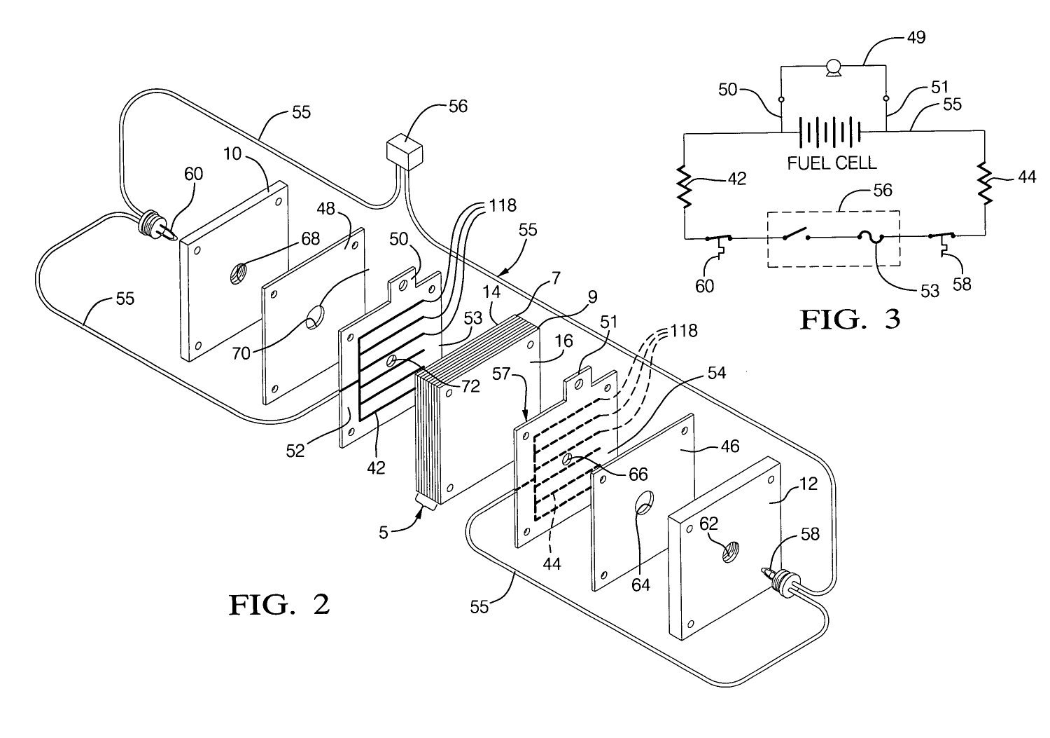

FIGS. 2 and 3 depict a PEM fuel cell stack comprising a pair of end cells 7 and 9 sandwiching a plurality of inboard cells 5 therebetween. Stack terminal plates 52 and 54 abut the monopolar cell end plates 14 and 16, respectively, while a layer of electrical-thermal insulation 48 and 46 abuts the terminal plates 52 and 54 respectively. Stack end plates 10 and 12 hold the stack together under compression. Electrical resistance heating elements 42 and 44 are recessed in the faces 53 and 57 of the terminal plates 52 and 54 that engage the cell end plates 14 and 16, and are connected to an electrical circuit 55 that includes (1) the fuel cell stack as the energy provider, (2) a starter switch 56 that is manually actuated by the stack operator at startup time, (3) a first thermomechanical, cut-out switch 58 (e.g. bimetal switch) engaging the cell end plate 16 through holes 62, 64, 66 in the centers of plates 12, 46 and 54, and (4) a second thermomechanical, cut-out switch 60 (e.g. bimetal switch) engaging the cell end plate 14 through holes 68, 70, and 72 in the centers of plates 10, 48 and 52. The switches 60, 58 are electrically insulated from the cell end plates 14, 16, and the terminal plates 52,54 to prevent stack shorting. The starter switch 56 includes a fuse 53 (see FIG. 3) for opening the circuit 55 in the event of an electrical overload. The thermomechanical cut-out switches 60, 58 are selected to open when the temperatures of the end cells reach a prescribed above-freezing temperature that is preferably about 20° C. to 40° C. One end 118 of each heating element 42, 44 is in electrical contact with its associated recess (i.e. in terminal plates 52 or 54, as appropriate), so that current generated by the stack passes through the circuit 55 and energizes the heating elements 42, 44. In this embodiment, two thermomechanical switches 58, 60 are used in electrical series connection such that the opening of only one switch cuts off current flow in the circuit 55. One of the thermomechanical switches may be set to open at a lower target temperature than the other. If the switch with the lower target temperature setting fails to open at its prescribed temperature, the other switch with the higher target opening temperature setting acts as a backup to cut off current flow in the heater circuit 55 once its opening temperature is reached.

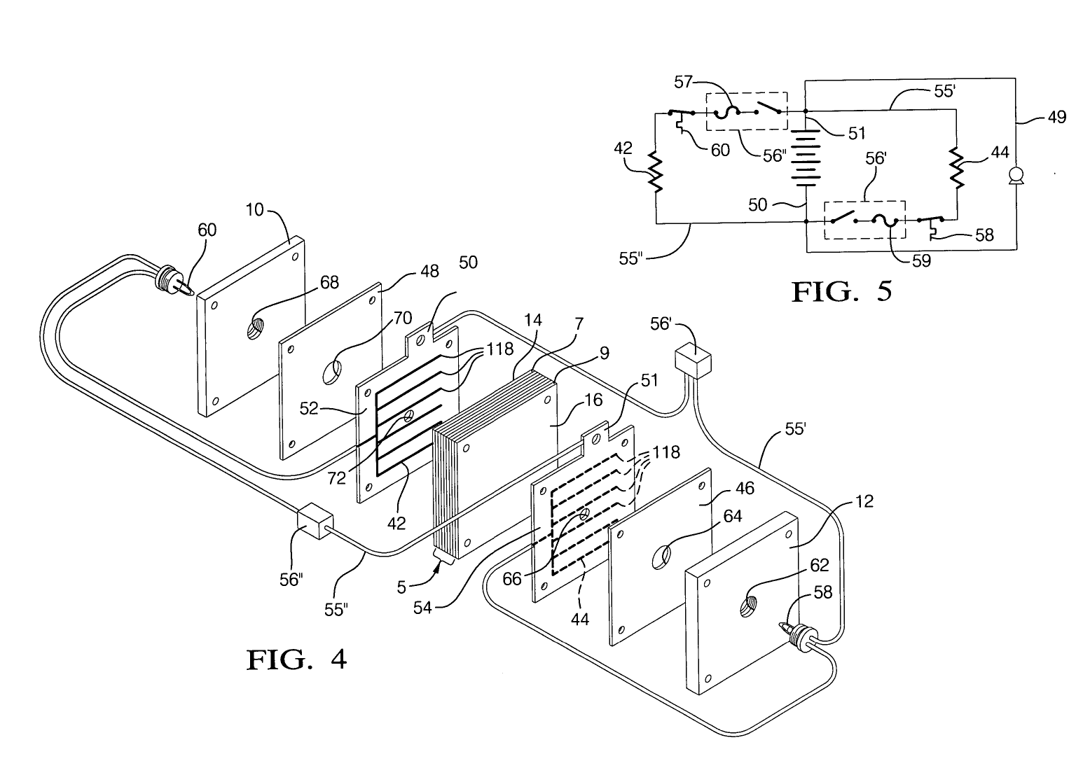

The embodiment shown in FIGS. 4 and 5 is similar to that shown in FIGS. 2 and 3 except that the thermomechanical cut-out switches 58 and 60 are connected in electrical parallel (rather than in series) such that each switch controls the “heater-off” target temperature for only one end cell, independently from the other end cell. More specifically, FIG. 4 depicts a PEM fuel cell stack comprising a pair of end cells 7 and 9 sandwiching a plurality of inboard cells 5 therebetween. Stack terminal plates 52 and 54 abut cell end plates 14 and 16, respectively, while layers of electrical-thermal insulation 48 and 46 abut the terminal plates 52 and 54, respectively. Stack end plates 10 and 12 apply compression to the stack, and hold it together. Electrical resistance heating elements 42 and 44 are recessed in the faces of the terminal plates 52 and 54 that engage the cell end plates 14 and 16. Each heater 42, 44 is part of an electrical circuit having electrically parallel branches 55′ and 55″ that includes (1) the fuel cell stack as the energy provider, (2) starter switches 56′, 56″ that are manually actuated by the stack operator at startup time, (3) a first thermomechanical, cut-out switch 58 (e.g. bimetal switch) engaging the cell end plate 16 through holes 62, 64, 66 in the centers of plates 12, 46 and 54, and (4) a second thermomechanical, cut-out switch 60 (e.g. bimetal switch) engaging the cell end plate 14 through holes 68, 70, and 72 in the centers of plates 10, 48 and 52. The starter switches 56′, 56″ each include a fuse 59, 57 (see FIG. 5) for opening the circuits 55′, 55″ in the event of an electrical overload. The thermomechanical cut-out switches 58, 60 are selected to open when the temperatures of the end cells associated therewith reach a prescribed, above-freezing temperature. The prescribed temperature will preferably be about 20° C. to about 40° C. As with FIG. 2, the ends 118 of the heating elements 44, 42 are in electrical contact with their mating recesses in the terminal plates 54, 52 so that current generated by the stack passes through the circuits 55′, 55″ and energizes the heating elements 44, 42. In this embodiment, both thermomechanical switches 58, 60 will typically be set to open at about the same target temperature.

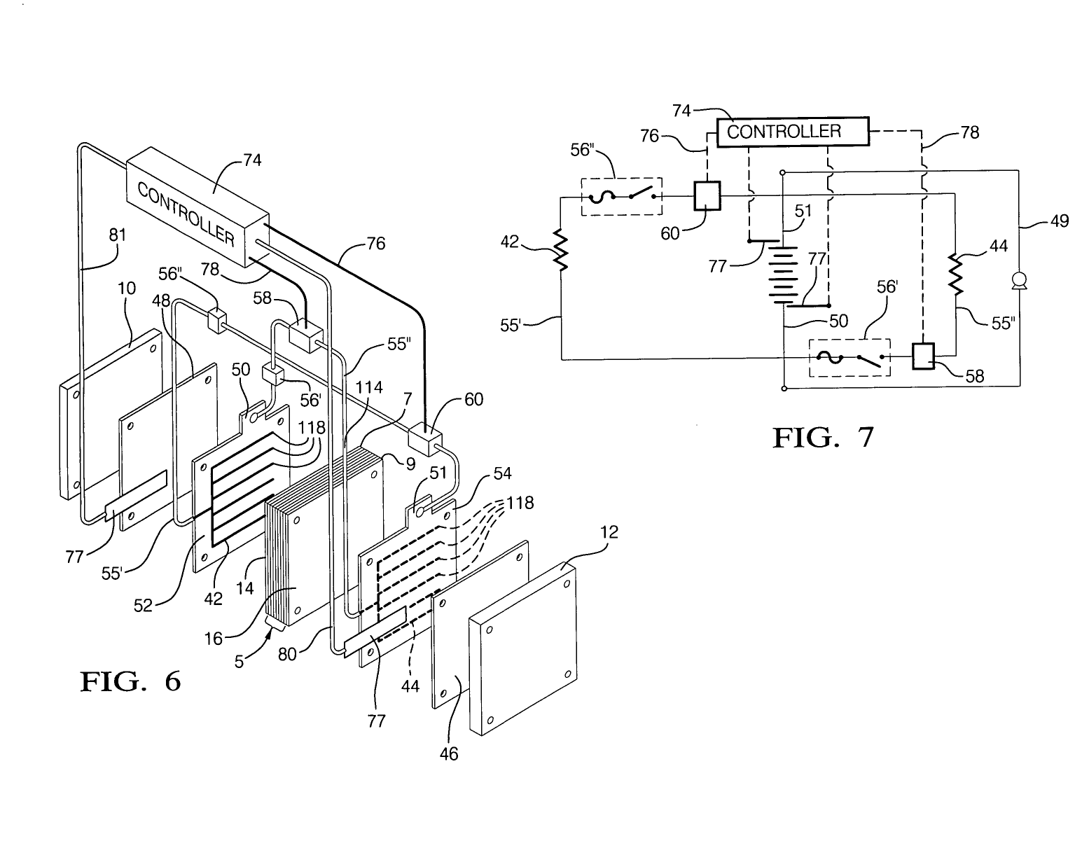

According to another embodiment of the invention shown in FIGS. 6 and 7 the thermomechanical cut-out switches of FIGS. 2-5 are replaced with thermosensors 77 that send end-cell-temperature signals to a controller 74, which, in turn, sends control signals 76, 78 to the cut-out switches 60, 58 for terminating current flow to the heater(s) when the target temperature is reached.

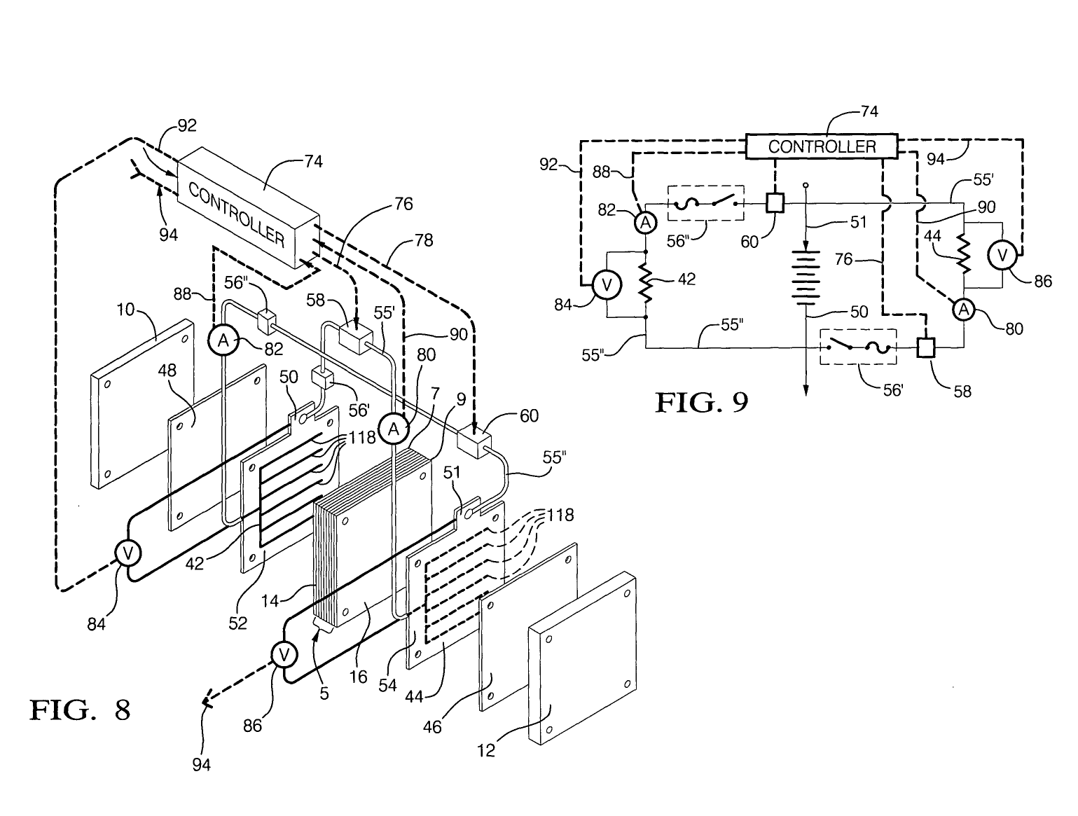

FIGS. 8 and 9 depict another embodiment of the invention that eliminates the aforesaid thermoswitches and the thermosensors. Instead, the embodiment of FIGS. 8 and 9 determines end cell temperatures by calculating the resistance across each heating element, which resistance varies with end cell temperature. The resistance is calculated by a controller from voltage and current measurements taken from the heater circuits. More specifically, FIGS. 8 and 9 depict a PEM fuel cell stack comprising a pair of end cells 7 and 9 sandwiching a plurality of inboard cells 5 therebetween. Stack terminal plates 52 and 54 abut monopolar cell end plates 14 and 16, respectively, while layers of electrical-thermal insulation 48 and 46 abut the terminal plates 52 and 54, respectively. Stack end plates 10 and 12 apply compression to the stack, and hold it together. Electrical resistance heating elements 42 and 44 are recessed in the faces of the terminal plates 52 and 54 that engage the cell end plates 14 and 16. Each heating element 42, 44 is connected in parallel to an electrical circuit having parallel branches 55′ and 55″ that includes (1) the fuel cell stack as the energy provider, (2) starter switches 56′, 56″ that are manually actuated by the stack operator at startup time, (3) a first cut-out switch 58, and (4) a second cut-out switch 60. Opening of the cut-out switches 58 and 60 is triggered by a controller 74 via control signals 76 and 78 when the temperatures of the end cells reach a prescribed, above-freezing temperature (preferably about 20° C. to about 40° C.). The temperatures of the end cells 7 and 9 are determined by calculating the resistance across each heater by the formula R=E/I using: (1) current measurements taken from ammeters 80 and 82 reported to controller 74 via signals 90 and 88; and (2) voltage measurements taken from volt meters 84 and 86 reported to controller 74 via signals 92 and 94. The controller 74 makes the necessary calculations, and temperature correlations, and sends the appropriate control signals 76 and 78 to the cutout switches 58 and 60. The starter switches 56′, 56″ each include a fuse (see FIG. 9) for opening the circuits 55′, 55″ in the event of an electrical overload. As with the other embodiments, the ends 118 of the heating elements 42, 44 are in electrical contact with recesses within which they reside in the terminal plates 52, 54 so that current generated by the stack passes through the circuits 55′, 55″ and energizes the heating elements 42, 44. The controller 74 may either be a controller that is dedicated strictly to the self-thawing technique of the present invention, or, preferably, will be a central controller that is used to control the many aspects of the entire fuel cell system—not just stack thawing. A suitable such central controller contains the necessary hardware and software for receiving inputs, converting inputs to other values correlated to inputs, summing inputs, generating internal signals based on those inputs, conditioning (i.e. integrating/differentiating) the internal signals to provide smooth output signals, and whatever other functions might be needed to control the fuel cell system, including the self-thawing routine of the present invention. Such a controller may take the form of a conventional general purpose, digital, computer-based controller programmed to periodically carry out a prescribed process, and include such well known elements as: (1) a central processing unit (CPU) with appropriate arithmetic and logic circuitry for carrying out arithmetic, logic, and control functions; (2) read-only memory (ROM); (3) read-write random access memory (RAM); (4) electronically programmable read only memory (EPROM); and (5) input and output circuitry which interfaces with the thermosensors, switches, clock(s)/timer(s), volt meters and/or ammeters inter alia. The ROM contains the instructions read and executed by the CPU to implement the several processes carried out by the controller. The EPROM contains appropriate look-up tables, and any needed calibration constants, for converting and comparing appropriate inputs/outputs. The controller processes the input signals to provide appropriate output control signals for the switches and clock(s)/timer(s).

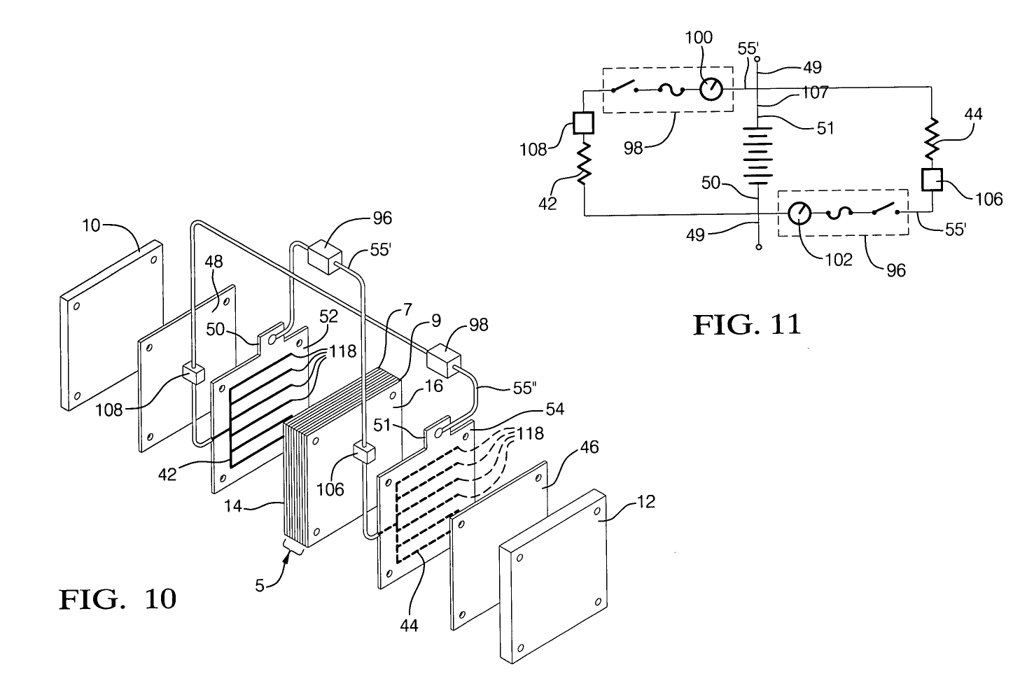

FIGS. 10 and 11 depict still another embodiment of the invention that eliminates reliance on end cell temperature measurements to trigger opening of the cutout switches. Rather, this embodiment simply energizes the heating elements for a prescribed length of time after actuating the starter switch. More specifically, FIGS. 10 and 11 depict a PEM fuel cell stack comprising a pair of end cells 7 and 9 sandwiching a plurality of inboard cells 5 therebetween. Stack terminal plates 52 and 54 abut monopolar cell end plates 14 and 16, respectively, while layers of electrical-thermal insulation 48 and 46 abut the terminal plates 52 and 54, respectively. Stack end plates 10 and 12 apply compression to the stack, and hold it together. Electrical resistance heating elements 42 and 44 are recessed in the faces of the terminal plates 52 and 54 that engage the cell end plates 14 and 16. Each heating element 42, 44 is connected to an electrical circuit having parallel branches 55′ and 55″ that includes (1) the fuel cell stack as the energy provider, and (2) combined starter/cut-out switches 96 and 98 each having a clock/timer 102, 100 integral therewith for opening the switches after a prescribed interval of time has passed following closing of the switches. Alternatively, the separate starter/cut-out switches 96 and 98 could be eliminated, and replaced with a single combined starter/cut-out switch that is connected to both heater circuits 55′ and 55″ (e.g. located in line 107 of FIG. 11). According to one variation of the timed-switch technique, the length of time the heater is “on” will vary with the ambient temperature at the time the stack is started-up. In this variation, ambient temperature is sensed, and reported back to a controller (not shown). The controller consults an empirically-derived lookup table that correlates ambient temperature to heating times, and then sends a control signal that sets the clock for an heating time specific to the ambient temperature (i.e. a short heat for warmer [albeit freezing] ambient temperatures, and a longer heat for colder ambient temperatures). When using a timer to control heating times, each circuit 55′, 55″ will preferably also include a PTC resistor 108, 106 in thermal contact with each of the end cells 7, 9 and responsive to the temperatures of the end cells. PTC resistors are comprised of a material that has a positive thermal coefficient of resistance (i.e. its electrical resistance increases as its temperature increases). Accordingly, the PTC resistor in this embodiment will be selected to stop current flow when the prescribed, target heater-on temperature is reached. Hence, as the temperatures of the end cells 7, 9 increase so does the resistance of the PTC resistor which, in turn, shuts-off current flow to the heating elements if the end cells reach a prescribed temperature before the clock(s)/timer(s) have timed-out and opened the switch(s) 96, 98. The starter/cut-out switches 96, 98 each include a fuse (see FIG. 9) for opening the circuits 55′, 55″ in the event of an electrical overload. As with the other embodiments, the ends 118 of the heating elements 42, 44 are in electrical contact with the terminal plates 52, 54 so that current generated by the stack passes through the circuits 55′, 55″ and energizes the heating elements 42,44.

A still further alternative is similar to that shown in FIGS. 10 and 11, but with the starter/cut-off switches 96 and 98, and PTC resistors 108, 106 eliminated and the heating elements 42 and 44 themselves formed from PTC-resistor material selected to cut-off current flow through the heating elements 42, 44 when a prescribed, above-freezing temperature is reached. A suitable PTC material for this purpose will cut-off current flow when the end cell temperature reaches about 5-60° C.

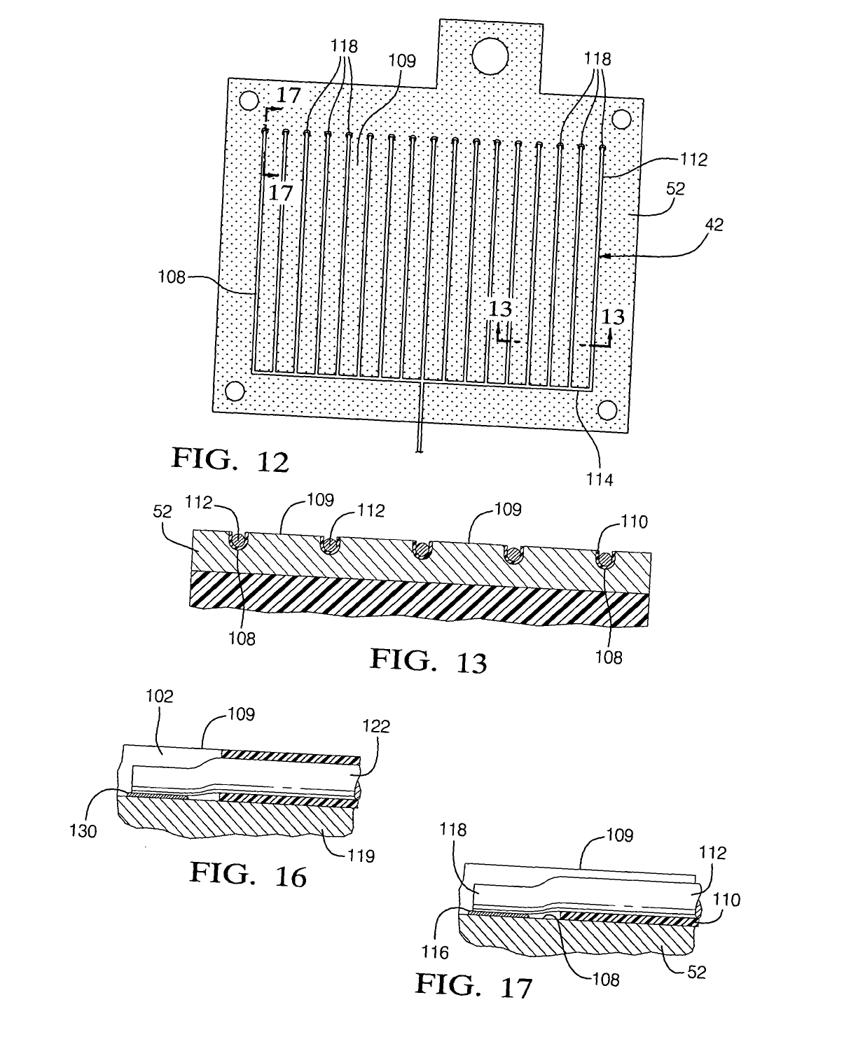

FIGS. 12, 13 and 17 show a terminal plate 52 having a plurality of recesses (i.e. grooves) 108 on the face thereof and separated one from the next by ridges or lands 109. The recesses 108 are lined with a layer of electrical insulation 110, and receive a plurality of resistance heating wires 112 therein. One end of each of the resistance heating wires 112 adjoins a common bus wire 114 along one edge of the plate 52. The other, distal ends 118 (see FIG. 17) of the wires 112 are welded, brazed, soldered 116, or otherwise bonded to the plate 52 in the recesses 108, so as to be in good electrical contact therewith. Thus, some of the current generated by the stack flows to/from the stack through the heating wires 112 and bus wire 114.

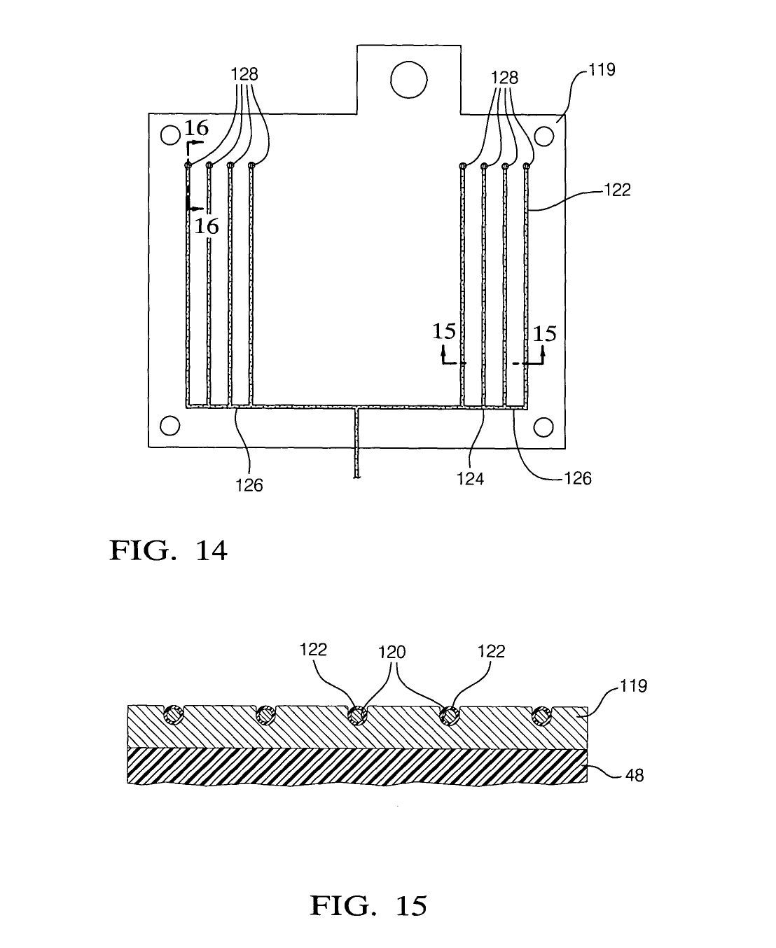

FIGS. 14-16 show a terminal plate 119 having a plurality of recesses 120 housing a plurality of electrically-insulated, resistance-heating wires 122 electrically adjoined to bus wire 124 at one end 126, and to the plate 119 at the other end 128 as by welding/brazing/soldering 130 or the like (see FIG. 16). FIG. 14 also shows an embodiment of the invention wherein the heater wires 122 cover only a portion of the face of the plate 119 rather than the entire face as shown in FIG. 14. In this embodiment, the number of heater wires is reduced, and the remaining wires so located as to locally apply the heat to those portions of the end plates 14, 16 that form the gas manifolds 17, 19 of the gas flow field (see FIG. 1) where ice-clogging is particularly troublesome (e.g. in the flow field manifolds). The heater wires 122 may be selectively located at various other sites on the plate adjacent regions of the end cell where more heat is particularly needed.

The above-described embodiments have shown the heating elements recessed in the faces of the terminal plates 52, 54 proximate the cell end plates 14 and 16. However, heating element location is not limited thereto. Rather the heating elements could advantageously be recessed in the outer faces of the cell end plates 14, 16 of end cells 7, 9 that confront the terminal plates 52 and 54. and thus closer to the flow field and MEA it heats.

How effectively the end cells are heated during a frozen start is a function of the size of the stack (i.e. the number and active area of each cell). While even a small amount of end cell heating is helpful to some extent, a large amount of heat is needed if the stack is to be thawed out in a short period of time. For example, for customer satisfaction reasons, a motive power, fuel cell stack used to power an electric vehicle should be completely thawed out, and ready to deliver motive power, in no more than about two minutes. For a PEM fuel cell made from Delrin® insulators 46, 48, aluminum terminal plates 52, 54, titanium cell end plates 14, 16, and Gore 5510 membrane-electrolyte we have determined that to achieve thaw times of about 2 minutes, a minimum of 70 cells per stack is needed, and a minimum power density of at least about 0.75 Watts per square centimeter of cell active area (i.e. 0.75 Watts/cm²) is needed for the heating elements. To achieve thaw times significantly less than 2 minutes, a heater power density of at least about 1.25 Watts/cm² is preferred, and about 1.75 Watts/cm² most preferred. At the 0.75 Watts/cm² power density level, a 600 Watt heating element is needed on each end of a stack of 800 cm² cells (i.e. a total of 1.2 kw for both ends). If that stack had 70 cells, the current draw would be about 9 amps/heater or 18 amps/stack, assuming no resistive, temperature and transport losses. This is doable since at −20° C., a modern PEM cell is capable of producing a current density of about 0.025 amperes per square centimeter of active area (i.e. 0.025 A/cm²). Thus a 70-cell stack of 800 cm² cells would be capable of generating 20 amps current and about 1.4 kW of power, which is more then enough to power both heating elements. A 100-cell stack would require only 12 amps to power both 600 watt heating elements, or would permit the use of two 1000 watt heating elements. A 200-cell stack would permit the use of two 2000 watt heating elements, and so on. Similarly, a 100-cell stack of 1000 cm² cells would permit the use of two 1250 watt heating elements, and so on. Needless to say, the more heat supplied to the end cells, the quicker their temperatures will rise. On the other hand, no practical benefit is seen to raising the temperatures of the end cells at a faster rate than that of the inboard cells. Hence, the upper practical limit to heater size is determined by the rate the inboard cells' temperature can be raised.

The materials used to construct a stack have an impact on how much power needs to be produced by the stack to heat the end cells. Hence for example, if the monopolar cell end plates 14, 16 were made from an ultra-thin material that has an ultra-high thermal conductivity, less stack power would be required than for thicker plates of a lower thermal conductivity material. Moreover, future improvements in the MEA materials could yield higher low temperature current densities which would result in smaller stacks being able to self-thaw themselves. Hence, it is anticipated that as materials of construction improve there will a lessoning of the heater and stack size requirements to practice the present invention.

### EXAMPLE

A stack comprising 14 cells (each having an active area of 803 cm²) was used to simulate self-thawing of a 200-cell stack. A 1.4 kW heating element was recessed in the inside face of the terminal plate 52, 54. The stack was placed in a refrigerator and frozen to a temperature of −40° C. H₂ and O₂ were then supplied to the stack until the stack reached its open circuit potential (i.e. ca. 14 volts). When open circuit potential was reached, a sufficient load was placed on the stack to draw 14 amps of current therefrom. At the same time, 14 amps of current was supplied to the heating elements (i.e. 7 amps/heater) from an external source, and the temperatures of the end cells monitored. The end cell temperatures reached 0° C. in 100 seconds and 20° C. in about 120 seconds. The same test was repeated, but without end cell heating, and resulted in the end cells reaching 0° C. in 160 seconds, and 20° C. in 210 seconds. Essentially the same test was repeated, but instead of measuring the end cell temperatures, the time it took for the stack to generate 480 amps output current was used as the target. The starting temperature for this test was −20° C. Without end cell heating, typical start times (i.e. time to target) were approximately 150 secs., with occasional failures due to ice-clogging. With end cell heating, the start times for the stack was reduced to about 25 secs. with no failures due to ice-clogging.

While the invention has been disclosed in terms of a specific embodiment thereof, it is not intended to be limited thereto, but rather only to the extent set forth hereafter in the claims which follow.

1. A self-thawing fuel cell stack comprising a plurality of inboard fuel cells sandwiched between a pair of end fuel cells, each of said end fuel cells including a monopolar cell end plate defining a terminus of said stack, an electrically conductive terminal plate abutting each of said cell end plates for delivering electrical current to a load circuit connected to said terminal plates, a low-resistance interface between said abutting plates, a recess in one of said abutting plates at said interface, an electrical-resistance heating element disposed within said recess for heating a said end cell when starting-up a frozen stack, and a heater circuit electrically connecting each said heating element to said stack for conducting electrical current generated by said stack through said heating elements to heat said end cells during said starting-up, said heater circuit including one or more switches that initiate(s) and maintain(s) said conducting until the temperature of said end cells reaches a prescribed, above-freezing, target temperature, and thereafter terminates said conducting.

2. A self-thawing fuel cell stack according to claim 1 wherein said heating element has a first end electrically connected to said one plate in said recess, and a second end electrically connected to said heater circuit.

3. A self-thawing fuel cell stack according to claim 1 wherein said heating elements are selectively positioned adjacent a region of said cell end plates that is most susceptible to ice-clogging during start-up of a frozen stack.

4. A self-thawing fuel cell stack according to claim 1 further including a layer of thermal insulation between said heating element and the ambient for minimizing heat losses from said end cells.

5. A self-thawing fuel cell according to claim 1 wherein said one or more switches include a thermo-mechanical switch engaging said cell end plate.

6. A self-thawing fuel cell according to claim 1 including a controller for triggering the opening of said one or more switches when said target temperature is reached, and a sensor for sensing and reporting said end cell's temperature to said controller.

7. A self-thawing fuel cell according to claim 6 wherein said sensor senses the voltage across the heating element and current in the heater circuit, and reports them to the controller for determination of the electrical resistance of the heating element and the corresponding cell temperature.

8. A self-thawing fuel cell according to claim 1 wherein said heating element comprises a plurality of branches each of which has a first end connected to a buss common to all the branches, and a second, distal end remote from said buss and electrically connected to said one plate in said recess.

9. A self-thawing fuel cell according to claim 1 wherein said recess comprises a plurality of valleys interdigitated with a plurality of ridges, said heating element is disposed within said valley, and said abutting plates form said interface at said ridges.

10. A self-thawing fuel cell according to claim 1 wherein said heater circuit is electrically parallel to said load circuit.
